(19) United States
(12) Patent Application Publication
(10) Pub. No.: US 2005/0025070 A1
(43) Pub. Date: Feb. 3, 2005

(54) Network device and setting apparatus therefor

(75) Inventor: Tetsuya Yamada, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/860,126

(22) Filed: Jun. 4, 2004

(30) Foreign Application Priority Data
Jun. 12, 2003 (JP) 2003-168407

(51) Int. Cl. H04L 12/28

(52) U.S. Cl. 370/254; 370/449

(57) ABSTRACT

This disclosure relates to reducing a load in setting a network device. Initial information necessary for connecting a printer (102) as a network device to a network is automatically assigned by a configurator server (103). Setting information which is necessary for causing a PC (104) to receive a service provided by the printer is collected from the printer (102) and managed by the configurator server (103).

### FIELD OF THE INVENTION

This invention relates to a dynamic setting technique for a device connected to a network and a setting information management technique.

### BACKGROUND OF THE INVENTION

For a device connected to a network, generally, appropriate setting must be executed before activation. Necessary setting items are unique to each network protocol. In, for example, a TCP/IP (Transmission Control Protocol/Internet Protocol) network, a unique name known as an IP address must be assigned to each device.

Only setting each information related to the TCP/IP, including such an IP address, imposes a great burden on a network manager. If setting for the entire network is changed, it becomes still more difficult for him/her because re-setting must be executed for all devices.

As techniques aiming at solving such problems of manual setting, RARP (Reverse Address Resolution Protocol), BOOTP (Bootstrap Protocol, RFC951) and DHCP (Dynamic Host Configuration Protocol, RFC1541, 2131) are known.

A method has conventionally been proposed, which causes a network manager to assign a new IP address or correct parameters by remote-controlling each network device (Japanese Patent Laid-Open No. 2000-122944).

The method described in the above patent reference is excellent because it allows remote control. However, it is still necessary for the network manager to manually set each network device.

A conventional DHCP server is outstanding because it can automatically assign IP addresses to a plurality of network devices. However, this server manages leased IP addresses and pooled IP addresses, and nothing more.

When these earlier works are used, a network device such as a PC or printer can be connected to a network. However, they cannot make it possible to use the network device such as a printer from a PC.

For example, to use a printer on a network, a printer port must be created on a PC. To do this, not only the assigned IP address but also information about the type of the printer must be grasped. Since various manufacturers are selling various peripheral devices such as printers, there are an enormous number of products. With the conventional methods, it is impossible to automatically acquire and manage detailed setting information of such network devices. Hence, the load on the manager is heavy.

As described above, there are conventionally methods for reducing the load on the network manager in setting network addresses such as IP addresses. However, to ultimately make a network device such as a printer usable, manual setting is necessary, and it still places a burden on the network manager.

### SUMMARY OF THE INVENTION

According to the present invention, the foregoing object is attained by providing an apparatus which causes a management server to automatically assign, to a network device, initial information necessary for connecting the network device to a network and collect setting information, which is necessary for causing a PC (Personal Computer) side to receive a service provided by the network device, from the network device and manage the setting information.

The invention is particularly advantageous since the load on the network manager can be reduced in network device setting processing by setting a network device and simultaneously acquiring information representing the type of the network device and storing it in a database.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic view showing an arrangement in which a network board according to the embodiment is connected to a printer;

FIG. 2 is a block diagram showing a schematic arrangement of the network board 101 according to the embodiment;

FIG. 3 is a block diagram showing the arrangement of a PC on which network setting software can run;

FIG. 4 is a view showing a packet header when a setting reference protocol according to the embodiment is incorporated in a TCP/IP protocol;

FIG. 5 is a view showing the payload data structure of a configurator packet according to the embodiment;

FIG. 6 is a flow chart of network device setting processing and management processing for setting information related to network devices in the embodiment;

FIG. 7 is a view showing a list to manage set devices according to the embodiment;

FIG. 8 is a view showing a network arrangement according to another embodiment; and

FIG. 9 is a flow chart of network device setting and registration processing according to the embodiment.

### DETAILED DESCRIPTION OF THE PREFERRED EMBODIMENTS

Preferred embodiments of the present invention will now be described in detail in accordance with the accompanying drawings.

### First Embodiment

<<Arrangement of LAN>>

The arrangement of a LAN (Local Area Network) according to this embodiment will be described first. At least one network device is connected to the LAN of this embodiment. The network devices are managed by network setting software.

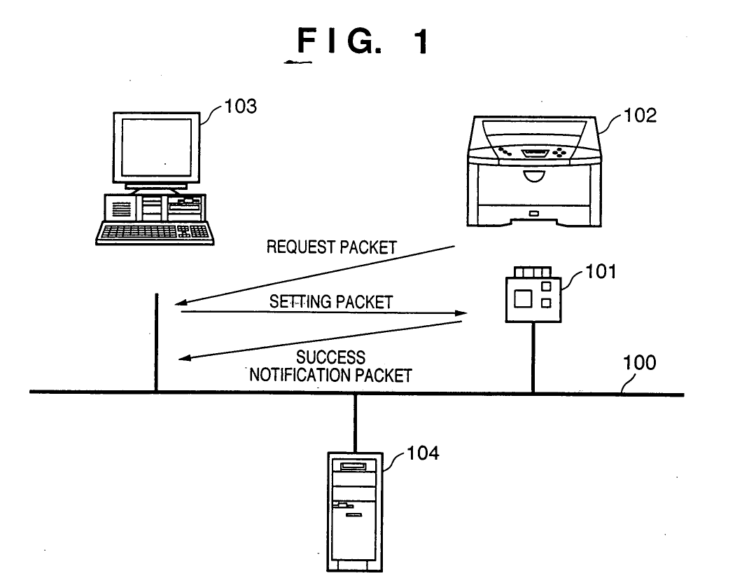

FIG. 1 is a view showing a network arrangement according to this embodiment. A printer 102 is connected to a local area network (LAN) 100 through a network board 101. Such a device connectable to a network will be referred to as a network device. The network board 101 may be either attached outside the network device or incorporated in the network device.

The network board 101 is connected to the LAN 100 through an interface such as 10Base-T having RJ-45 connector. Personal computers (PCs) 103 and 104 are also connected to the LAN 100. The PCs can communicate with the network board 101 through the LAN 100. The PC 103 functions as a server which sets and manages a network device. The PC 104 functions as a host computer to use the printer.

<<Arrangement of Network Board>>

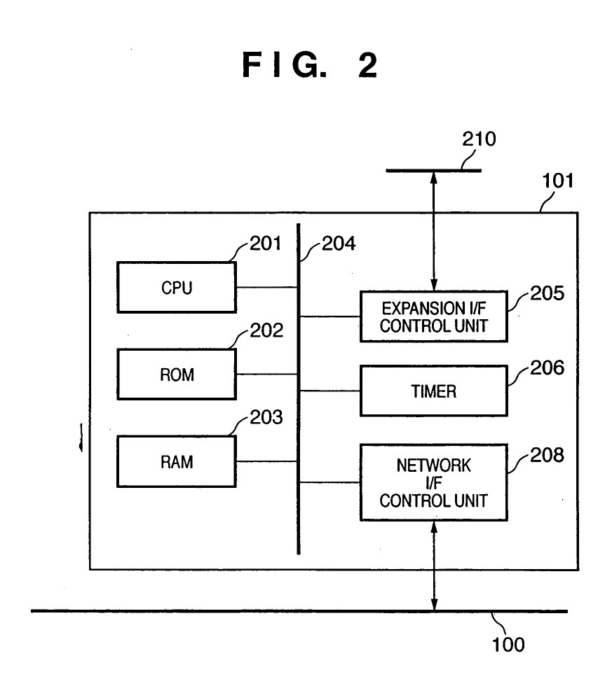

FIG. 2 is a block diagram showing a schematic arrangement of the network board 101 according to this embodiment. The network board 101 comprises a CPU 201, ROM 202, RAM 203, bus 204, expansion I/F control unit 205, timer 206, and network I/F control unit 208. The CPU 201 controls the entire network board. The ROM 202 stores a program which controls the network board. The RAM 203 is used as the work area of the CPU 201. The network I/F control unit 208 controls connection with the network. The network board 101 can be connected not only to the printer but also various network devices such as a facsimile apparatus, copying machine, and multifunction apparatus.

<<Arrangement of PC>>

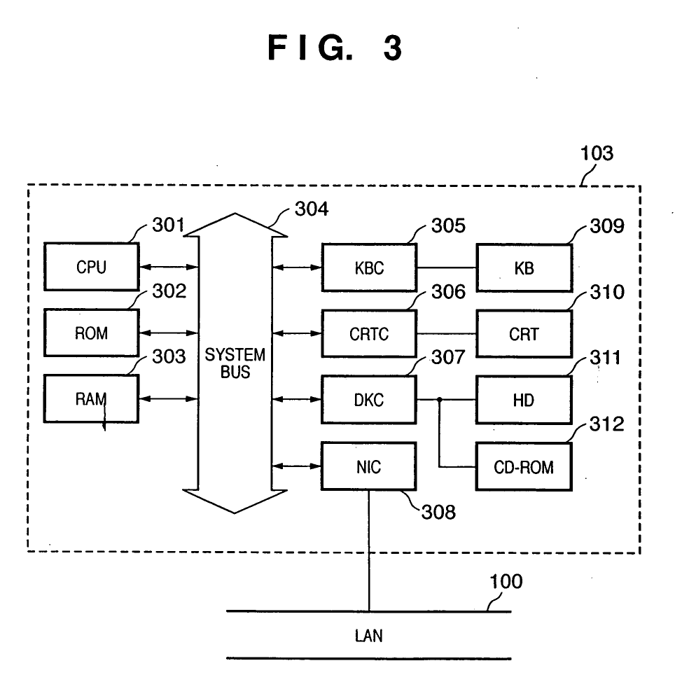

FIG. 3 is a block diagram showing the arrangement of a PC on which network setting software can run. Referring to FIG. 3, network setting software runs on the PC 103. The PC 103 has a CPU 301 which executes a network setting program which is stored in a ROM 302 or hard disk drive (HD) 311 or supplied from a storage medium such as a CD-ROM 312. The PC 103 collectively controls the devices connected to a system bus 304. A RAM 303 is a storage device which functions as the main memory or work area of the CPU 301. A keyboard controller (KBC) 305 controls a designation input from a keyboard (KB) 309 or pointing device (not shown). A CRT controller (CRTC) 306 controls display on a CRT display (CRT) 310. A disk-controller (DKC) 307 controls access to the hard disk (HD) 311 and CD-ROM 312, which store the boot program, various applications edit files, user files, network setting program, and the like. A network board 308 bidirectionally transmits/receives data to/from an agent or network device through the LAN 100.

<<Configurator Packet>>

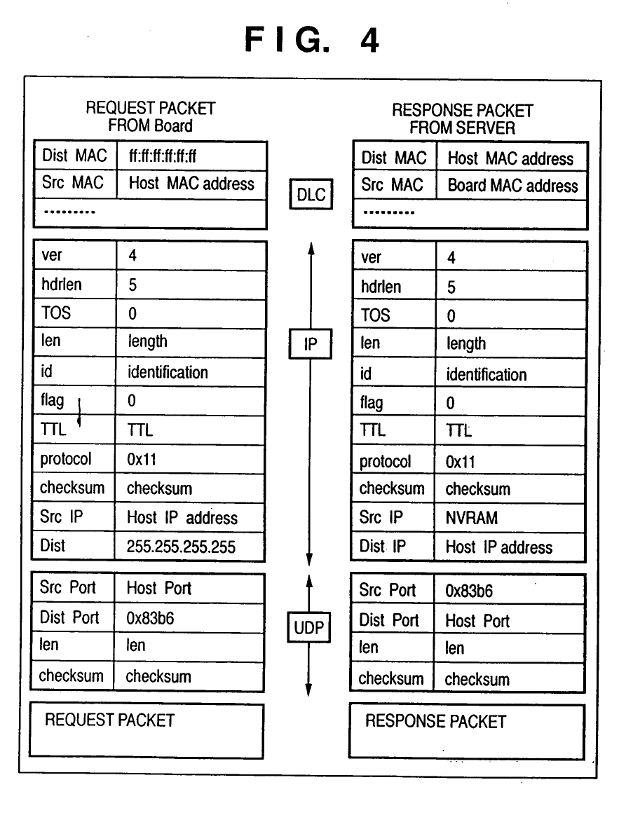

FIG. 4 is a view showing a packet header when a setting reference protocol according to the embodiment is incorporated in a TCP/IP protocol. The unique setting reference protocol will be referred to as a configurator protocol. In this embodiment, the configurator protocol is incorporated in a UDP. However, the present invention is not limited to this, and the configurator protocol may be incorporated in another protocol.

In the example shown in FIG. 4, the configurator protocol uses, for example, 0x83b6 as the port number of the UDP, “255.255.255.255” as the IP address of a request packet transmission destination, and 0xffffffffffff as a MAC address (Dest MAC). When the destination MAC address is 0xffffffffffff, this packet is handled as a broadcast packet. All devices connected to the network receive this packet.

Setting, reference, and resetting of the network board 101 from the PC 103 are implemented by using this configurator protocol.

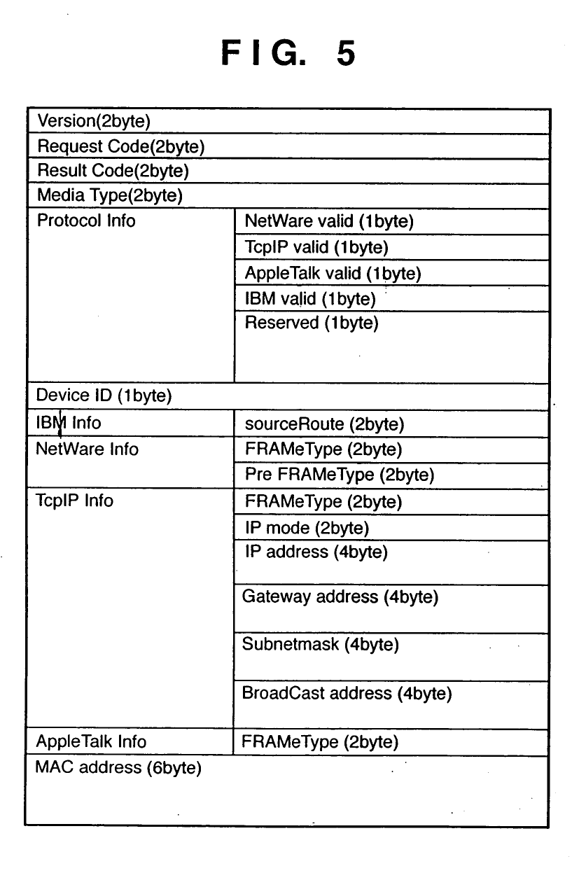

FIG. 5 is a view showing the payload data structure of the configurator packet according to this embodiment. Details of parameters are as follows. Version (2 byte) parameter indicates the version of the configurator packet. Request Code (2 byte) parameter is a code that represents the function requested by using the packet. For example, this parameter has the following meaning.

0: Set (set)

1: Get (refer)

2: NVRAM-Reset (reset by NVRAM value)

3: Factory-Reset (reset by factory shipment value)

4: Discovery (search)

5: Set-Request (set request)

Result Code (2 byte) parameter is a code representing the result for the request. For example, this parameter has the following meaning.

0x0000: Success

0x0001: Media type error

0x0002: No designated protocol stack

0x0003: Version error

0x0100: Protocol setting error (details unknown)

0x0101: Protocol setting error (NetWare IPX)

0x0102: Protocol setting error (TcpIP)

0x0104: Protocol setting error (AppleTalk)

0x0108: Protocol setting error (TokenRing)

Media type (2 byte) parameter indicates a communication medium. For example, this parameter has the following meaning.

0: EtherNet

1: TokenRing

Device ID parameter is an identifier unique to the type of the device (product) to be set.

Protocol Info parameter is a flag corresponding to each protocol information. When Request Code is 0, it means execution of setting processing. For this reason, only information related to a protocol for which Protocol Info parameter is set to 1 is set.

NetWare Info is a field where information related to NetWare (registered trademark) is to be set and referred to. FRAMeType (2 byte) indicates a frame type to be used by NetWare.

For EtherNet (registered trademark), and by way of example, the parameter has the following meaning.

0: Disable (NetWare is unusable)

1: 802.3

2: 802.2

4: EtherNet II

8: 802.2SNAP

16: AutoSense

For TokenRing, and by way of example, this parameter has the following meaning.

0: Disable (NetWare is unusable)

1: TOKENRING

2: TOKEN_SNAP

TcpIP Info is a field where information related to TcpIP is to be set and referred to.

FRAMeType (2 byte) indicates a frame type to be used by TcpIP.

0: Disable (TcpIP is unusable)

4: EtherNet II

IP Mode (2 byte) indicates an IP address deciding method. For example, the following values are ORed at the time of reference.

0: IP fixed (rise from NVRAM value)

1: BOOTP valid

2: RARP valid

3: DHCP valid

IP address (4 bytes) indicates the IP address of the network board.

Gateway Address (4 bytes) indicates the gateway address of the network board.

Subnetmask (4 bytes) indicates the subnet mask of the network board.

AppleTalk Info is a field where information related to AppleTalk (registered trademark) is to be set and referred to.

FRAMeType (2 bytes) indicates a frame type to be used by AppleTalk.

0: Disable (AppleTalk is unusable)

1: Phase1

2: Phase2

3: Phase1 and Phase2

MAD address (6 bytes) indicates the MAC address of the board.

When Request Code has a value except 4 (Discovery), and the value in this field does not coincide with the MAC address of the network board, the packet is neglected.

<<Setting Sequence>>

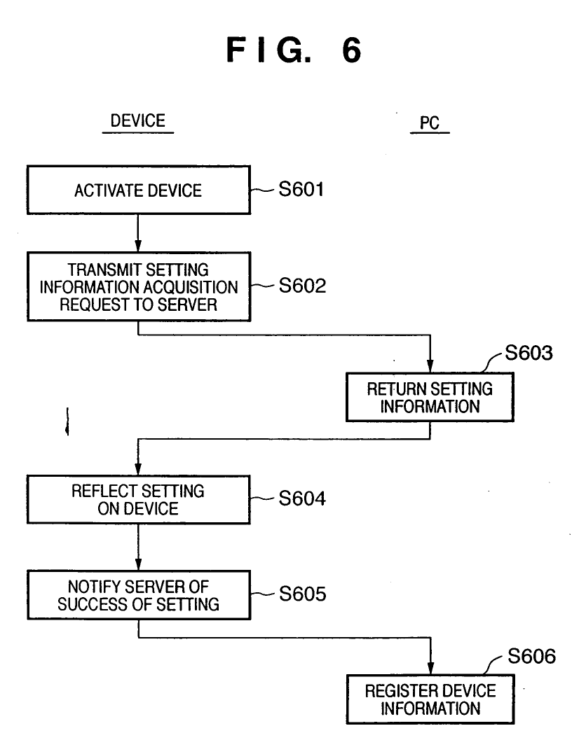

FIG. 6 is a flow chart of network device setting processing and management processing for setting information related to network devices in this embodiment. This flow chart corresponds to processing for causing the network board 101 that constitutes part of the network device to transmit, to a broadcast address, a request packet to request setting information at the time of activation, appropriately setting the network board 101 on the basis of a response packet, and registering the setting information of the network device in the PC 103.

In step S601, the network board 101 is powered on and activated.

In step S602, the CPU 201 of the network board 101 broadcasts a configurator packet to request setting information necessary for connection to the network from the PC 103.

In step S603, in accordance with the network setting software activated on the PC 103 functioning as a configurator server: the CPU 301 receives the setting request packet by controlling the NIC 308. Subsequently, the CPU 301 reads out, from a storage device such as the HD 311, one of assignable IP addresses ensured for network devices and setting information such as the subnet mask unique to the network 100 connected to the network board 101 and server 103 and a gateway address, overwrites the information on the received configurator packet to create a setting packet, and returns the packet to the network board 101.

In step S604, the CPU 201 of the network board 101 receives the setting packet by controlling the network I/F control unit 208 and reflects the setting information on the protocol stack of the network board 101. More specifically, the setting information is stored in the ROM 202 such as an EEPROM. Accordingly, the setting information is stored in a storage area accessible by the protocol stack to connect the network. When reflection of the setting information on the network board has successfully be done, the flow advances to step S605.

In step S605, the CPU 201 of the network board 101 sets a code (0x0000) which represents the success in Result Code of the configurator packet. The CPU 201 also reads out Device ID stored in the storage device such as the ROM 202 to create a success notification packet and transmits the packet to the server 103. Device ID is an identifier representing the type of a product. The success notification packet may contain an identifier that identifies the device in addition to Device ID.

Alternatively, the CPU 201 may request, of the printer 102, Device ID stored in its ROM by controlling the expansion I/F control unit 205. Upon receiving Device ID transmitted from the printer 102, the CPU 201 may incorporate the received Device ID on the success notification packet.

In step S606, the CPU 301 of the server 103 receives the success notification packet by controlling the NIC 308. The CPU 301 refers to the MAC address, IP address, and Device ID (product type) in the packet, registers these pieces of information in a list to manage set devices, and stores the information in the hard disk drive 311.

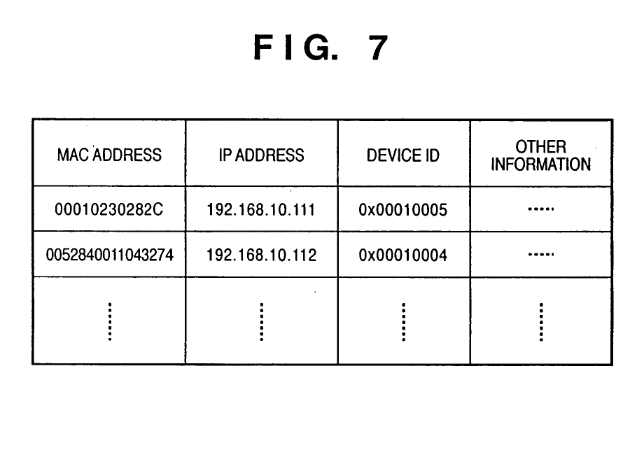

FIG. 7 is a view showing an example of the device management list to manage set devices according to this embodiment. The MAC address, IP address, device ID, and other information acquired from the network board 101 or each network device such as the printer 102 are stored in the list. These pieces of information are setting information necessary for making the network board 101 usable in the PC 104. For example, when a printer is connected as a network device, the setting information contains an IP address necessary for creating a printer port and identification information representing the type of the printer.

As described above, according to this embodiment, when processes including network board setting processing to registration processing of a network device in a server are executed by using a configurator packet, the load of device setting and management on the network manager can be lower than before.

### Second Embodiment

In the above-described embodiment, the network device side requests setting information of the server and reflects the setting information received from the server on setting. That is, the network device triggers the processing.

In the second embodiment, the server side triggers the processing. This embodiment is especially useful when setting of the network itself is changed, and the new setting should be reflected on each network device. The same reference numerals as in the first embodiment denote the same parts in the second embodiment, and a detailed description thereof will be omitted.

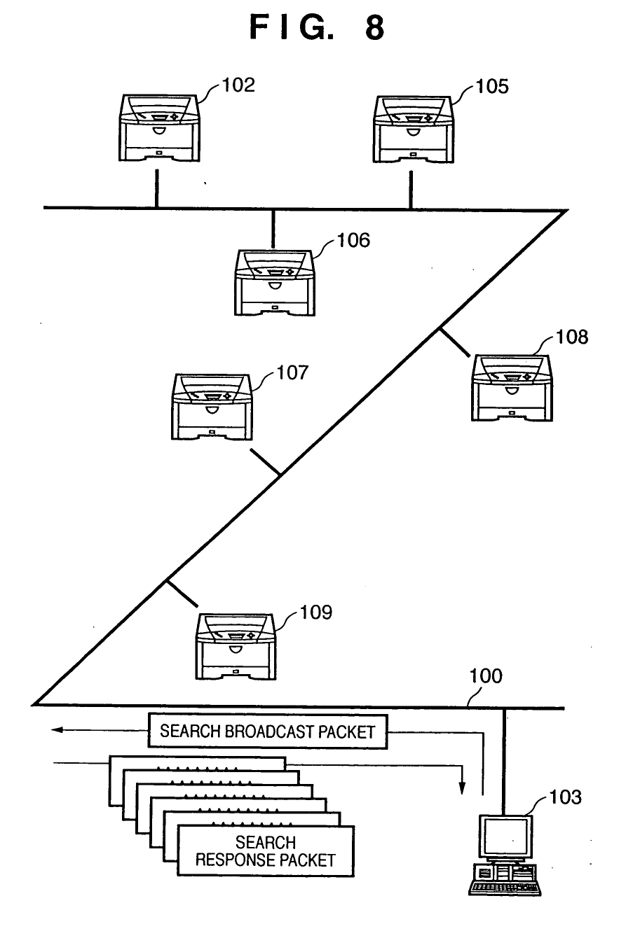

FIG. 8 is a view showing a network arrangement according to this embodiment. A configurator server 103 broadcasts a search packet to search for a network device connected to the network. Upon receiving the search packet, each of printers 102 and 105 to 109 returns a search response packet in accordance with a predetermined rule.

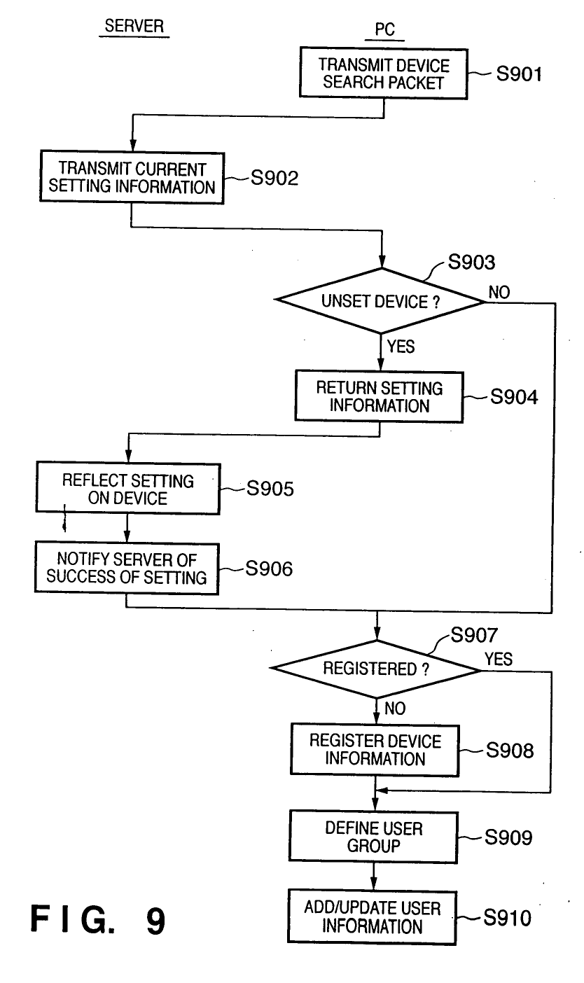

FIG. 9 is a flow chart of network device setting and registration processing according to this embodiment.

In step S901, a CPU 301 of the server 103 sets “4: Discovery (search)” in Request Code of a configurator packet in accordance with network setting software and broadcasts the configurator packet for search by controlling an NIC 308.

In step S902, a CPU 201 of each of the printers 102 and 105 to 109 receives the configurator packet for search by controlling a network I/F control unit 208. The CPU 201 also reads out current network setting information stored in a ROM 202 or the like and overwrites the setting information on the received configurator packet to create a configurator packet for response. The CPU 201 transmits the created response configurator packet to the server 103 by controlling the network I/F control unit 208.

In step S903, a CPU 301 of the server 103 receives the response packet from each printer in accordance with the network setting software. The CPU 301 reads out the setting information contained in the received response packet and determines whether network setting for the printer that has transmitted the response packet has not been done yet.

For example, if the setting information maintains the state at factory shipment, it may be determined that the printer is still unset. Alternatively, it may be determined that the printer is still unset when the IP address of the printer, which is contained in the setting information, falls outside the range of valid IP addresses which are estimated from the IP address and subnet mask set in the server 103.

Alternatively, search by the configurator packet and search by SNMP (Simple Network Management Protocol) may be executed in parallel. A printer that has returns only a response to the configurator packet may be determined as an unset device. This uses a fact that only a network device assigned an authentic IP address should respond to search by SNMP.

If YES in step S903, the flow advances to step S904. If NO in step S903, the flow advances to step S907.

In step S904, the CPU 301 of the server 103 overwrites appropriate network setting information on the received configurator packet to create a configurator packet for setting and transmits the configurator packet to the unset printer.

In step S905, the CPU 201 of the unset printer receives the configurator packet. When it is determined that the configurator packet is a packet for setting, the CPU 201 reads out the setting information contained in the received configurator packet and reflects the setting on the printer itself. More specifically, the CPU 201 stores the setting information such as the IP address, subnet mask, and gateway in a storage device such as the ROM 202 such that the protocol stack can use the setting information.

In step S906, upon determining that setting is ended, the CPU 201 creates a success notification packet representing that the above-described setting has successfully be done and transmits the success notification packet to the server 103. This success notification packet contains type information such as a device ID representing the type of the network device and other setting information.

In step S907, the CPU 301 of the server 103 determines whether the printer that has transmitted the success notification packet is already registered in the database. The database is stored in, for example, a hard disk drive 311. If YES in step S907, the flow advances to step S909. If NO in step S907, the flow advances to step S908.

In step S908, the CPU 301 newly registers, in the database, the setting information contained in the received success notification packet. The database may be created either by using a known directory service such as an active directory or as a unique user management database. Examples of object properties of a network device are as follows.
MAC address
IP address
Port name
Product name
Version
Device name
Identification information of a group which can use the network device

In step S909, the CPU 301 defines a user group, as needed. For example, when the business department has a right to use a color printer, and the management department has no right, the business department is defined as a use permitted group, and the management department is defined as a use inhibited group. If the device ID of the printer indicates a product classified into a color printer, setting is done such that the printer can be used for the use permitted group.

In step S910, the CPU 301 executes change or addition of user information. For example, an arbitrary user is allocated to a user group that can use the printer registered in the above step and registered in the user management database. Accordingly, the user can use the printer newly connected to the network.

As described above, according to this embodiment, the server 103 executes necessary network setting for a network device and registers the set network device in the database. In addition, the server 103 also registers information about users who can use the network device. With this processing, the load on the network manager can be reduced.

More specifically, conventionally, the setting information for each network device and information about users who can use each network device are separately managed. Hence, the load of operations that need to be executed by the network manager before the start of the service is heavy. According to this embodiment, however, network device setting, registration of its information, and addition of user information are executed as a series of operations. In addition, these pieces of information are unitarily managed. Hence, the labor of the network manager can be reduced.

### Other Embodiment

In the above-described embodiments, the CPU 201 of the network board 101 takes initiative of processing. Instead, a CPU incorporated in the printer 102 may take initiative of the above-described processing.

In the above-described embodiments, a printer has been exemplified as a network device. However, the present invention does not depend on the type of network device and can be applied to various kinds of network devices.

Steps S907 to S910 may be executed after network device setting processing (S601 to S605) described in the first embodiment.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

1. A device setting apparatus for setting a network device connected to a network, comprising:
a first reception component which receives a setting request transmitted from the network device;
a transmission component which transmits setting information to set the network device upon receiving the setting request;
a second reception component which receives at least one of device type information representing a device type of the network device and identification information which identifies the device, which are transmitted from the network device after the setting information is received by the network device and reflected on the network device; and
a registration component which registers at least one of the device type information and the identification information as information necessary for using the network device.

2. The apparatus according to claim 1, further comprising a management component which defines and manages, on the basis of at least one of the device type information and the identification information, a user group which has a right to use the network device.

3. A network device which executes network setting by communicating with a predetermined information processing apparatus, comprising:
a first transmission component which transmits, to the information processing apparatus, a transmission request of setting information necessary for connection to a network;
a reception component which receives the setting information transmitted from the information processing apparatus as a response to the transmission request;
a storage component which stores the setting information in a storage area accessible by a protocol stack for connection to the network upon receiving the setting information; and
a second transmission component which transmits at least one of device type information representing a type of the device and identification information which identifies the device to the information processing apparatus to register at least one of the device type information and the identification information in the information processing apparatus.

4. A device setting apparatus for setting a network device connected to a network, comprising:
a first transmission component which transmits request information to request current setting information to at least one network device connected to the network;
a first reception component which receives the current setting information transmitted from the network device;
a determination component which determines whether the setting information received by said first reception component is inappropriate in the network;
a second transmission component which transmits setting information to set the network device when it is determined that the setting information is inappropriate;
a second reception component which receives at least one of device type information representing a type of the device and identification information which identifies the device, which are transmitted from the network device after the setting information is received by the network device and reflected on the network device; and
a registration component which registers at least one of the device type information and the identification information as information necessary for using the network device.

5. The apparatus according to claim 4, further comprising a management component which defines and manages, on the basis of the device type information, a user group which has a right to use the network device.

6. A network device which executes network setting by communicating with a predetermined information processing apparatus, comprising:
a first storage component which stores current setting information in the network device;
a first reception component which receives a transmission request for the current setting information from the information processing apparatus;
a first transmission component which transmits the setting information stored in said first storage component upon receiving the transmission request;
a second reception component which receives new setting information transmitted from the information processing apparatus;
a second storage component which stores the new setting information in a storage area accessible by a protocol stack for connection to the network upon receiving the new setting information; and
a second transmission component which transmits at least one of device type information representing a type of the device and identification information which identifies the device to the information processing apparatus to register at least one of the device type information and the identification information in the information processing apparatus as information necessary for using the network device.

7. A device setting method of setting a network device connected to a network, comprising:
a first reception step of receiving a setting request transmitted from the network device;
a transmission step of transmitting setting information to set the network device to the network device upon receiving the setting request;
a second reception step of receiving at least one of device type information representing a type of the device and identification information which identifies the device, which are transmitted from the network device after the setting information is received by the network device and reflected on the network device; and
a registration step of registering at least one of the device type information and the identification information as information necessary for using the network device.

8. A device setting method of setting a network device connected to a network, comprising:
a first transmission step of transmitting request information to request current setting information to at least one network device connected to the network;
a first reception step of receiving the current setting information transmitted from the network device;
a determination step of determining whether the setting information received in the first reception step is inappropriate in the network;
a second transmission step of transmitting setting information to set the network device to the network device when it is determined that the setting information is inappropriate;
a second reception step of receiving at least one of device type information representing a type of the device and identification information which identifies the device, which are transmitted from the network device after the setting information is received by the network device and reflected on the network device; and
a registration step of registering at least one of the device type information and the identification information as information necessary for using the network device.

9. A device setting program for setting a network device connected to a network, the program having program codes for causing a computer to execute steps of:
receiving a setting request transmitted from the network device;
transmitting setting information to set the network device upon receiving the setting request;
receiving at least one of device type information representing a type of the device and identification information which identifies the device, which are transmitted from the network device after the setting information is received by the network device and reflected on the network device; and
registering at least one of the device type information and the identification information as information necessary for using the network device.

10. The program according to claim 9, further comprising a step of defining and managing, on the basis of the device type information, a user group which has a right to use the network device.

11. A setting program which executes network setting for a network device by communicating with a predetermined information processing apparatus, the program including program codes for causing a network device to execute steps of:
transmitting, to the information processing apparatus, a transmission request of setting information necessary for connection to a network;
receiving the setting information transmitted from the information processing apparatus as a response to the transmission request;
storing the setting information in a storage area accessible by a protocol stack for connection to the network upon receiving the setting information; and
transmitting at least one of device type information representing a type of the device and identification information which identifies the device to the information processing apparatus to register, in the information processing apparatus, at least one of the device type information and the identification information as information necessary for using the network device.

12. A device setting program for setting a network device connected to a network, the program including program codes for causing a computer to execute steps of:
transmitting request information to request current setting information to at least one network device connected to the network;
receiving the current setting information transmitted from the network device;
determining whether the received setting information is inappropriate in the network;
transmitting setting information to set the network device when it is determined that the setting information is inappropriate;
receiving at least one of device type information representing a type of the device and identification information which identifies the device, which are transmitted from the network device after the setting information is received by the network device and reflected on the network device; and
registering at least one of the device type information and t identification information as information necessary for using the network device.

13. The program according to claim 12, further comprising a step of defining and managing, on the basis of at least one of the device type information and the identification information, a user group which has a right to use the network device.

14. A network device setting program which executes network setting in cooperation with a predetermined information processing apparatus, the program including program codes for causing a network device to execute steps of:
receiving a transmission request for current setting information in the network device from the information processing apparatus;
reading out the current setting information from a storage device which stores the current setting information and transmitting the current setting information to the information processing apparatus;
receiving new setting information transmitted from the information processing apparatus;
storing the new setting information in a storage area accessible by a protocol stack for connection to the network upon receiving the new setting information; and
transmitting at least one of device type information representing a type of the device and identification information which identifies the device to the information processing apparatus to register, in the information processing apparatus, at least one of the device type information and the identification information as information necessary for using the network device.
